(19) United States
(12) Patent Application Publication
(10) Pub. No.: US 2012/0265575 A1
(43) Pub. Date: Oct. 18, 2012

(54) TASK COORDINATION SUPPORT SYSTEM AND TASK COORDINATION SUPPORT METHOD

(75) Inventors: Kentaro Torii, Yokohama-shi (JP); Naoshi Uchihira, Kawasaki-shi (JP); Tetsuro Chino, Kawasaki-shi (JP); Toshiaki Tanaka, Tokyo (JP)

(73) Assignee: KABUSHIKI KAISHA TOSHIBA, Tokyo (JP)

(21) Appl. No.: 13/414,792

(22) Filed: Mar. 8, 2012

(30) Foreign Application Priority Data
Apr. 15, 2011 (JP) 2011-091492

(51) Int. Cl. G06Q 10/06

(52) U.S. Cl. 705/7.15

(57) ABSTRACT

There is provided a task coordination support system for staffs each holding a mobile terminal in which the task information storage stores information on tasks to be implemented by the staff and task flow information showing constraint on order to implement the tasks, the receiving unit receives sensor information from the mobile terminal, the storage stores received sensor information therein, the estimating unit calculates, for each of the tasks, accuracy at which a predetermined implementation status is reached and estimates a task reached the predetermined implementation status among tasks not yet reached the predetermined implementation status, and the tweet message generator/deliverer generate a message corresponding to an estimated task, determine as a destination of the message a mobile terminal of a staff previously related to the estimated task which is different from the staff in charge of the estimated task and deliver the message to the mobile terminal.

### CROSS REFERENCE TO RELATED APPLICATIONS

This application is based upon and claims the benefit of priority from the prior Japanese Patent Application No. 2011-091492, filed on Apr. 15, 2011, the entire contents of which are incorporated herein by reference.

### FIELD

Embodiments relate to a task coordination support system and a task coordination support method which support task coordination at a job site where a plurality of staffs works in coordination.

### BACKGROUND

At a job site where a plurality of staffs belonging to a plurality of job titles works in coordination as in the case of maintenance services for a hospital, a nursing facility, a restaurant and facilities (building, elevator, electric power station, factory, etc), the staff have hitherto been required to grasp progress statuses of other tasks related to the task scheduled to be done by the staff himself or herself in order to perform the task at high efficiency by smoothing the coordination. The hospital generally adopts a method of querying the staffs who implement the related tasks by use of a mobile phone (in-hospital PHS (Personal Handyphone System)), however, it is impossible to grasp the progress status if the queried person is unable to answer the phone. Further, reversely it might happen to get contact with the related staff by phone in order to get other staffs to grasp the progress statuses of the tasks, however, similarly such a problem arose that the queried person is unable to answer the phone or forgets this action itself.

Further, there is a case in which a system capable of recording the task implementations through electronic medical records enables the progress statuses of the related tasks to be grasped. In this system, however, the progress status cannot be grasped unless the staff himself or herself goes to confirm the information, and hence the grasp thereof cannot be attained if forgetting the confirmation action itself. Moreover, the implementation of the task is not necessarily recorded immediately after carrying out the task, and therefore there is a case of lacking in property of real time. Furthermore, if there are no detailed records of the task implementations, the system described above has a problem that the progress status of the task cannot be grasped.

Further, there is known a system of recognizing the operation by using only an IC tag and associating this IC tag with voice confirmation of the worker. In this system, however, a plurality of tasks is carried out at the same location as at the hospital, in which case a problem is that it is not feasible to recognize which operation is on the implementation. On the other hand, there is known a system of specifying the task by employing only voice data. In this system, however, such a problem arises that the worker must periodically utter voices showing in detail which task is started or on the implementation or finished. Still further, with a simple combination of those technologies, the system and users do not cooperate in operation, so that it is not feasible to obviate such a problem that a person must take detailed actions voluntarily and frequently for recording (the task implementation) and uttering the voices.

### BRIEF DESCRIPTION OF THE DRAWINGS

FIG. 1 is a block diagram illustrating a task coordination support system according to a basic embodiment;

FIG. 2 is a block diagram illustrating a task coordination support system according to an embodiment;

FIG. 3 is a block diagram illustrating a configuration of a mobile terminal;

FIG. 4 is a diagram showing task schedule information;

FIG. 5 is a diagram illustrating a task information table;

FIG. 6 is a diagram illustrating task flow information tables;

FIG. 7 is a flowchart showing an operation of a first estimating unit;

FIG. 8 is a diagram depicting a relation between a variety of task schedule ID lists generated by the first estimating unit;

FIG. 9 illustrates an example of the task implementation status estimated result;

FIG. 10 is a flowchart illustrating an operation of a query unit;

FIG. 11 is a flowchart illustrating an operation of a response receiving unit;

FIG. 12 is a flowchart illustrating an operation of a second estimating unit;

FIG. 13 is a flowchart illustrating an operation of a task progress status notifier;

FIG. 14 is a diagram showing the task schedules and stay locations of nurses;

FIG. 15 is a diagram illustrating average implementation time of the tasks;

FIG. 16 is a diagram showing average movement requirement time between two locations;

FIG. 17 is a diagram illustrating task schedule implementation sequences of the nurses;

FIG. 18 is a diagram depicting respective movement line lengths in the two implementation sequences;

FIG. 19 is a diagram showing an example of time required for implementing the task without utilizing the embodiment;

FIG. 20 is a diagram showing another example of the time required for implementing the task without utilizing the embodiment;

FIG. 21 is a diagram illustrating a tweet data browse page;

FIG. 22 is a diagram illustrating how a list of tweets of members in a specified post is displayed;

FIG. 23 is a whole block diagram according to a sixth embodiment;

FIG. 24 is a block diagram of a tweet message destination determiner;

FIG. 25 is a diagram showing a status estimated result;

FIG. 26 is a diagram illustrating a tweet destination attribute selection rule;

FIG. 27 is a diagram illustrating an example of a destination attribute table: and

FIG. 28 is a flowchart showing a tweet message destination determining procedure.

### DETAILED DESCRIPTION

According to an embodiment, there is provided a task coordination support system for staffs each holding a mobile terminal, including a task information storage, a sensor data receiving unit, a status storage, an estimating unit and a tweet message generator/deliverer.

The task information storage stores information on tasks to be implemented by the staff and task flow information showing constraint on order to implement the tasks.

The sensor data receiving unit receives sensor information from the mobile terminal.

The status storage stores task status information containing received sensor information therein.

The estimating unit calculates, for each of the tasks, accuracy at which a predetermined implementation status is reached based on the task information storage and the status storage and estimates a task reached the predetermined implementation status among tasks not yet reached the predetermined implementation status based on calculated accuracy.

The tweet message generator/deliverer generate a message corresponding to an estimated task, determine as a destination of the message a mobile terminal of a staff previously related to the estimated task which is different from the staff in charge of the estimated task, and deliver the message to a determined mobile terminal.

In-depth descriptions of embodiments will hereinafter be made with reference to the drawings.

### Basic Embodiment

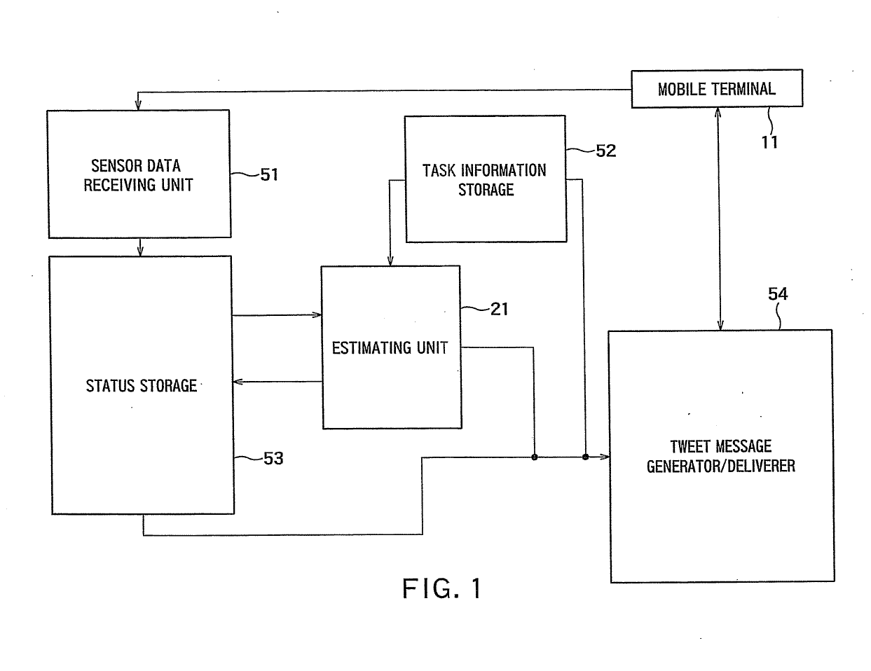

FIG. 1 illustrates architecture of a task coordination support system according to a basic embodiment.

The task coordination support system includes a sensor data receiving unit 51, a task information storage 52, a status storage 53, a tweet message generator/deliverer 54 and an estimating unit 21. The task coordination support system supports task coordination among individual staffs each holding a mobile terminal 11 in a way that employs these units.

The task information storage 52 retains, for each of the staffs, information on tasks to be implemented (i.e., task schedules) and task flow information showing constraint on order to implement the tasks.

The sensor data receiving unit 51 receives sensor information from the mobile terminals 11 held by the staffs.

The status storage 53 retains task status information containing the sensor information received by the sensor data receiving unit 51.

The estimating unit 21 calculates, based on the information stored by the task information storage 52 and the sensor information stored by the status storage 53, accuracy (e.g., probability) at which an predetermined implementation status predefined is reached for each of the tasks, and estimates the task reached the predetermined implementation status based on the thus-calculated accuracy among task not yet reached the predetermined implementation status. The status storage 53 retains an estimated result. The above-stated predetermined implementation status includes, for example, “started”, “completed”, and “implementation-underway” and so on.

The tweet message generator/deliverer 54 generates a message corresponding to the estimated task by the estimating unit 21, determines as a destination of the message the mobile terminal 11 of the staff related to the estimated task which is different from the staff in charge of the estimated task and delivers the message to the determined mobile terminal.

First, second, third, fourth, fifth and sixth embodiments based on the basic embodiment such as this will hereinafter be discussed. Details of the operations of the respective units will be further clarified in the discussions on these embodiments.

### First Embodiment

The embodiment aims at estimating a task progress status without imposing any burden on the staff other than making a simple response by estimating, based on sensor information and a task scheduled, an implementation task underway on the side of the staff and querying the staff about whether the estimated task is completed or not. The embodiment further aims at notifying in real time other staffs, required to grasp that the task will have been completed, of a purport that the task has already been completed by receiving a response to the query from the staff and estimating again the task progress status on the basis of a content of the response.

More specifically, the embodiment relates to a task coordination support system and a task coordination support method, which include the following functions, on a work front where a plurality of persons works in coordination:
1) a first function is to estimate, with respect to each of the staffs, the present implementation task of the staff from voices uttered by the staff, the present time, a present location of the staff, goods used, a task schedule of a current day and an implementation history of each task on the task schedule;
2) a second function is to transmit, to the terminal held by each staff, a query message (a voice message or a text message) for prompting each staff to make the response about the task progress status at a proper timing corresponding to the present estimated implementation task of each staff;
3) a third function is to receive a simple response (a voice or depression information of a button (event information) on a terminal screen, and tweet data in text etc.) to the query message, the response being made by each staff on the terminal;
4) a fourth function is to estimate again the task progress status from the received response; 5) a fifth function is to generate a task progress status notifying message that facilitates an understanding of the task progress status for other staffs by complementing or translating the received response in a way that uses items of information on the task such as a name of the task and a name of a service target (a patient etc) of the task.
6) a sixth function is to transmit the task progress status notifying message (by voice or in text) to the terminals held by other staffs required to grasp the task progress status; and
7) a seventh function is to improve, in the estimation of the present implementation task of the staff with respect to the first function “1”, an estimation probability of the implementation task by removing the task schedule(s) not plausible in the implementation underway from a result of the task estimation in a manner that uses the tweet data if a plurality of task schedules are entered in the same time zone on the task schedule of the current day.

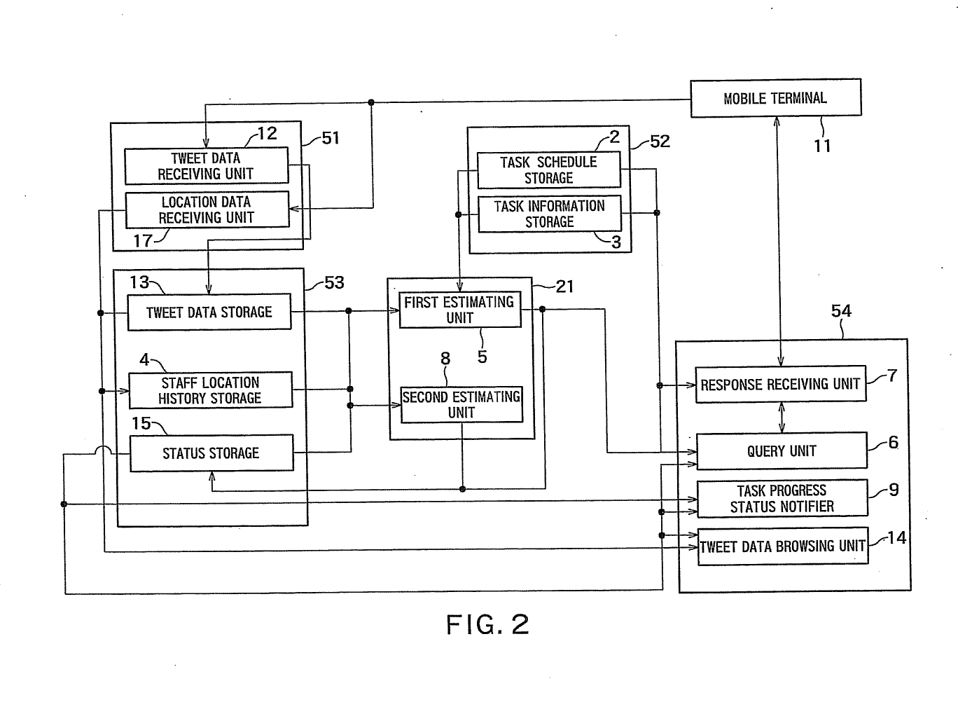

FIG. 2 is a block diagram depicting the task coordination support system according to a first embodiment. The sensor data receiving unit 51 includes a tweet data receiving unit 12 and a location data receiving unit 17.

The task information storage 52 includes a task schedule storage 2 and a task information storage 3.

The status storage 53 includes a tweet data storage 13, a staff location history storage 4 and a status storage 15.

The tweet message generator/deliverer 54 includes a response receiving unit 7, a query unit 6, a task progress status notifier 9 and a tweet data browsing unit 14.

The estimating unit 21 includes a first estimating unit 5 and a second estimating unit 8.

The task schedule storage 2 retains task schedule information containing a list of task schedules on a day-by-day basis or on a per duty time zone basis of each staff.

The task information storage 3 retains a task information table containing records of data entered in a “task ID” field, a “task flow ID” field, a “task name” field, a “type of task in charge” field, a “usage instrument ID” field, an “average implementation time” field and an “implementation time standard deviation” field with respect to the tasks such as receiving an instruction and performing co-injections and an injection.

Further, the task information storage 3 retains a task flow information table wherein the task flow information table contains task flow information which represents a precedent relationship and a descendant relationship between the tasks. The task flow is exemplified such as an injection flow, an oral drug administration flow and a blood collection flow. A task flow includes a plurality of tasks each forming one procedure.

The staff location history storage 4 retains a history of the location information of the staff. The location data receiving unit 17 can collect the histories of the location information of the staffs at a fixed time interval T via a variety of expedients such as Wi-Fi (Wireless Fidelity) of an RFIDs (Radio Frequency Identification tags; IC tags) and smartphones that are carried by the individual staffs or indoor GPS (iGPS) and ZigBee. The staff location history storage 4 gets stored inside with the location information acquired by the location data receiving unit 17. The location information is not limited to this acquisition mode but can be acquired by use of an arbitrary sensor. For example, the location information of the staff may be acquired by analyzing an image captured by a camera installed within a building. Further, sounds (voices) within the building are picked up by employing a microphone, and the picked-up sounds are combined with a result of the image analysis, thereby enabling the location of the staff to be narrowed down with higher accuracy. Moreover, the location information can be also acquired by utilizing the GPS (Global Positioning System).

Moreover, the staff location history storage 4 obtains staff stay starting time information representing a point of time since which the staff starts staying in the location by use of a location information history of the staff, and retains inside the staff stay starting time information.

The first estimating unit 5, at an interval of a fixed period of time, estimates the present task implementation of each staff to generate a task implementation status estimated result (which will be described in more detail later). The first estimating unit 5 gets the status storage 15 to store the thus-generated task implementation status estimated result. In this time, the first estimating unit 5 calculates already-implemented accuracy (e.g., an already-implemented probability) or implementation-underway accuracy (e.g., an implementation-underway probability) with respect to each task schedule. The first embodiment involves using the probability as the accuracy, however, a different expedient than the probability may also be employed.

Moreover, the first estimating unit 5 generates a descendant task schedule ID list being an ID list of descendant task schedules wherein before the tasks of the descendant task schedules are implemented, the implementation of the estimated present implementation task schedule should be completed. The first estimating unit 5 gets the status storage 15 to store the thus-generated descendant task schedule ID list.

The query unit 6 includes a query message information storage, a query message generating unit, a query message transmitting unit and a query message transmission time calculator. The query unit 6 executes the following processes by using these units. Namely, the query unit 6 generates a query message for querying about whether or not the implementation is completed with respect to the task schedule specified by the task implementation status estimated result. Then, the query unit 6 calculates the time when transmitting the query message, then specifies the staff to whom the query message is transmitted, and transmits the query message to the mobile terminal 11 etc. held by the staff at the calculated transmission time.

The response receiving unit 7 receives a response to the query message from the mobile terminal 11 etc. held by the staff. The response receiving unit 7, upon receiving the response, specifies query message information corresponding to the received response by use of response reception time and a response sender staff ID specified by the mobile terminal ID of a response sender. Then, the response receiving unit 7 thus associates the query messages with the responses.

The second estimating unit 8 updates the already-implemented probability and the implementation-underway probability of the task related to the task schedule specified by an estimated implementation task schedule ID in the query message information based on a content of the response from the staff, which is associated with the query message by the response receiving unit 7.

The task progress status notifier 9 selects the task of which the already-implemented probability is “1” or equal to or larger than a fixed value from among the task schedules specified by the task implementation status estimated result. Then, the task progress status notifier 9 generates a message for conveying a purport that the implementation of the task schedule is completed, and sends the message to the mobile terminal 11 held by the staff in charge of implementation in the task schedule specified by the descendant task schedule ID list.

The tweet data receiving unit 12 receives the tweet data transmitted from the mobile terminal 11 held by the staff.

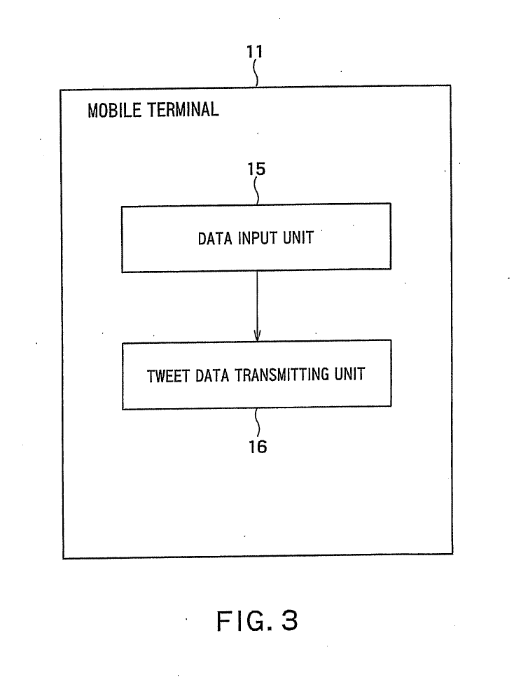

As depicted in FIG. 3, the mobile terminal 11 held by the staff is provided with a data input unit 15 which accepts the voice uttered by the staff as the data. The data input unit 15 may also accept inputs of text data and image data in addition to the voice data. These items of data accepted by the data input unit 15 are generically referred to as tweet data. The tweet data transmitting unit 16 transmits, to the tweet data receiving unit 12, the tweet data together with attached items of information such as the present time, the present location of the staff, the staff ID and the nearest patient ID.

Multiple types of communication mediums such as (wired and wireless) LANs (Local Area Networks) and 3G (3rd Generation) are available between the tweet data transmitting unit 16 and the tweet data receiving unit 12. The tweet data storage 13 retains the tweet data and the attached information thereto, which are received by the tweet data receiving unit 12.

The first estimating unit 5 can enhance the estimation precision of the implementation task by using the tweet data stored by the tweet data storage 13.

To be specific, if the plurality of task schedules is entered in the same time zone on the task schedule of the current day, it is feasible to remove the task schedule not plausible in the implementation underway from the task estimated result by use of the tweet data. The estimation probability of the implementation task can be thereby improved, and the estimation of the implementation task can be performed with the still higher accuracy.

For instance, an assumption is that a nurse A has two task schedules such as measuring vital data (body temperature, blood pressure, etc) of a patient B and a patient C during a period of, e.g., 10:00 am through 11:00 am. Supposing that a patient ID of the nearest patient in the tweet data belongs to the patient B at a point of time of 10:05 am, it can be determined that the task of measuring the vital data of the patient C is not yet implemented at 10:05 am, and hence this task schedule can be removed from the task estimated result. There is, it can be thereby determined, a high probability that the implementation of the task of measuring the vital data of the patient B is underway.

Herein, the estimated implementation task may be added to the tweet data stored by the tweet data storage 13.

Further, when the tweet data is categorized as the voice data, a voice recognition unit converts the voice data into text data, and this text data can be added as voice text data.

Still further, it is feasible to extract only a single word of a proper part of speech by a morphological analysis from within the voice, text data and extract an important lexicon from within the voice text data by keyword matching.

The tweet data browsing unit 14 displays the tweet data (containing the voice text data and the keyword therein) stored by the tweet data storage 13. The tweet data browsing unit 14 can also narrow down the tweet data to be displayed corresponding to attributes (post, job title, qualification, etc.) of the user who browses the tweet data and the staff ID contained in the tweet data.

(Task Schedule Storage 2)

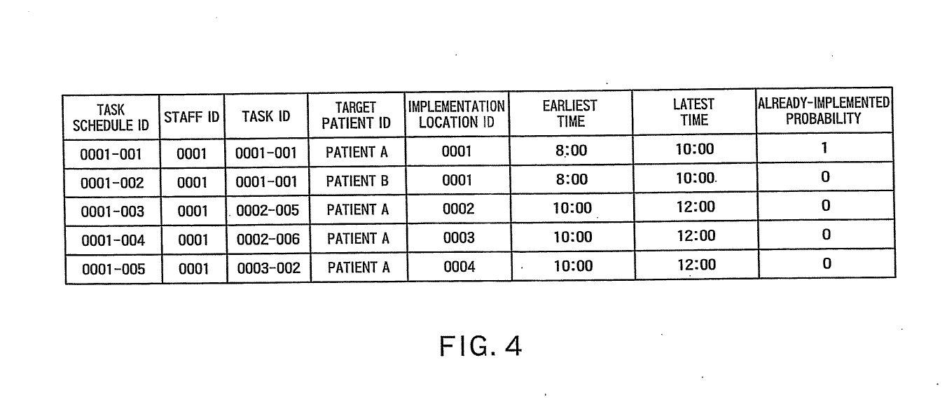

FIG. 4 illustrates an example of the task schedule information stored by the task schedule storage 2.

Each individual staff has a plurality of task schedules in a given time zone such as 8:00 am-10:00 am. An actual task implementation sequence is determined depending on the situation.

Each set of data (one record) of the task schedule information is called the task schedule (one record corresponds to one task schedule). The task schedule (one record) contains a “task schedule ID” field, a “staff ID” field, a “task ID” field, a “task target patient ID” field, an “implementation location ID” field, an “earliest time” field, a “latest time” field and an “already-implemented probability” field (0: certainly not yet implemented, 1: certainly already implemented).

Herein, the “earliest time” represents a start of the time zone for implementing the task specified in the task schedule, while the “latest time” represents an end of the time zone for implementing the task schedule.

The status storage 15 retains, in addition to the task schedule information, the task implementation status estimated result, the precedent task schedule ID list and the descendant task schedule ID list, which are generated by the first estimating unit 5.

In the task schedule ID “0001-001”, the left value “0001” represents a staff ID, while the right value “001” represents a task schedule ID. In the task ID “0001-001”, the left value “0001” indicates a task flow ID, while the right value “001” indicates a task ID (implementation task ID).

(Task Information Storage 3)

The task information storage 3 retains, as described above, the task information table and the task flow information table.

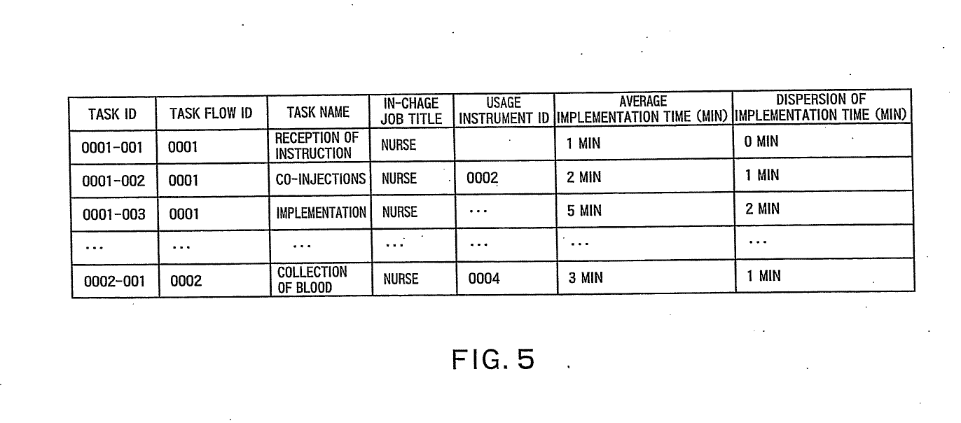

FIG. 5 depicts an example of the task information table.

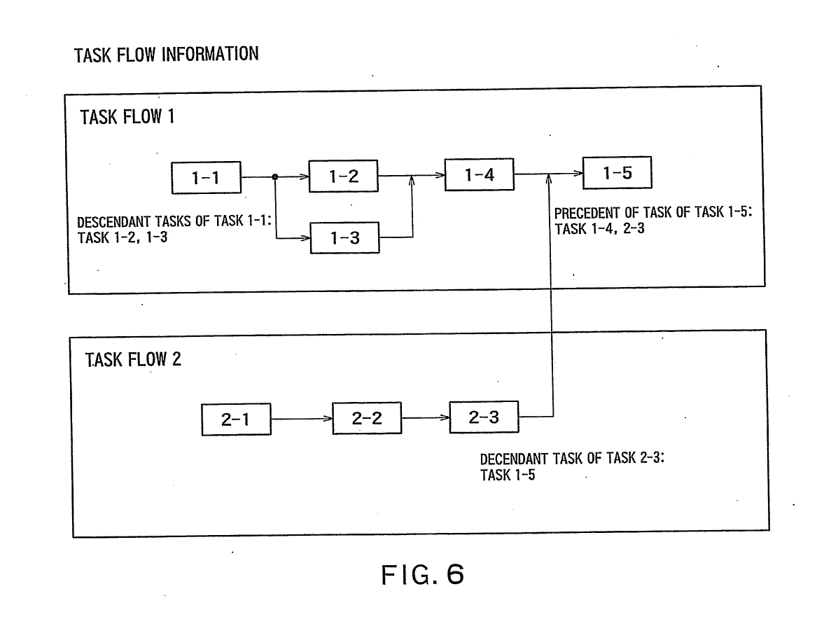

FIG. 6 depicts an example of the task flow information table. FIG. 6 exemplifies two flows of the task flow information. The task flow information retains, with respect to each task, a task flow ID, a task ID, a precedent task ID and a descendant task ID.

Each of rectangles in FIG. 6 represents the task, and a character string (1-1, 1-2, etc) within the rectangle indicates the task ID. These tasks are connected by arrows representing an implementation sequence, thus configuring the task flow.

The precedent tasks are tasks implemented just before the target task and are generally plural tasks. The descendant tasks are tasks implemented just after the target task and are generally plural tasks. It might happen that the precedent task and the descendant task do not belong to the same task flow.

In FIG. 6, the tasks 1-2 and 1-3 are descendant to the task 1-1, but none of the tasks are precedent to the task 1-1. The tasks 1-4 and 2-3 are precedent to the task 1-5, but none of the tasks are descendant to the task 1-5.

(Staff Location History Storage 4)

[Staff Location History Information]

The staff location history information is defined as a history of the location information of the staff. The location data receiving unit 17 obtains the location information of the staff at the fixed time interval T from the mobile terminal of the staff. The mobile terminal may be mounted with the RFID. The location data receiving unit 17 may receive the data via an antenna installed in the building.

The staff location history, storage 4 retains the staff location history information containing a record of an “observation time” field, a “staff ID” field and a “location ID” field. Note that the staff ID, if written to the RFID, may be acquired from this RFID and can be also obtained from login information of an application on the mobile terminal.

[Staff Stay Starting Time Information]

Throughout an overall period of observation time extending from a certain point of time ts up to the present time t, a location ID of a certain staff A indicates one given place p, in which case the staff A can be presumed to stay in a location s up to the present time t from the time ts onward.

In this case, the time ts is set as the time when the staff A starts staying in the location s. This stay starting time is updated when the present location of the staff changes.

The staff location history storage 4 calculates and retains a record of a “staff ID” field, a “location ID” field and a “stay starting time” field as the staff stay starting time information.

(First Estimating Unit)

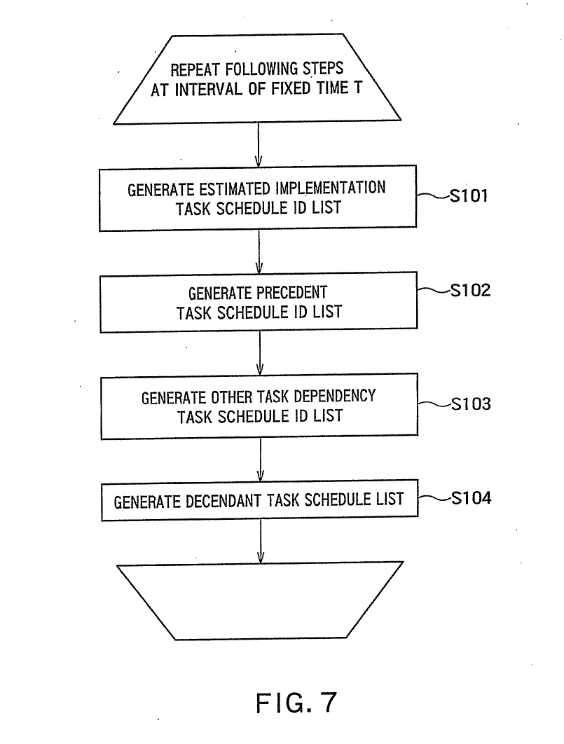

FIG. 7 illustrates a flowchart of an operation of the first estimating unit 5. The following is an in-depth description of respective steps in the flowchart.

[Generation of Task Implementation Status Estimated Result: S101]

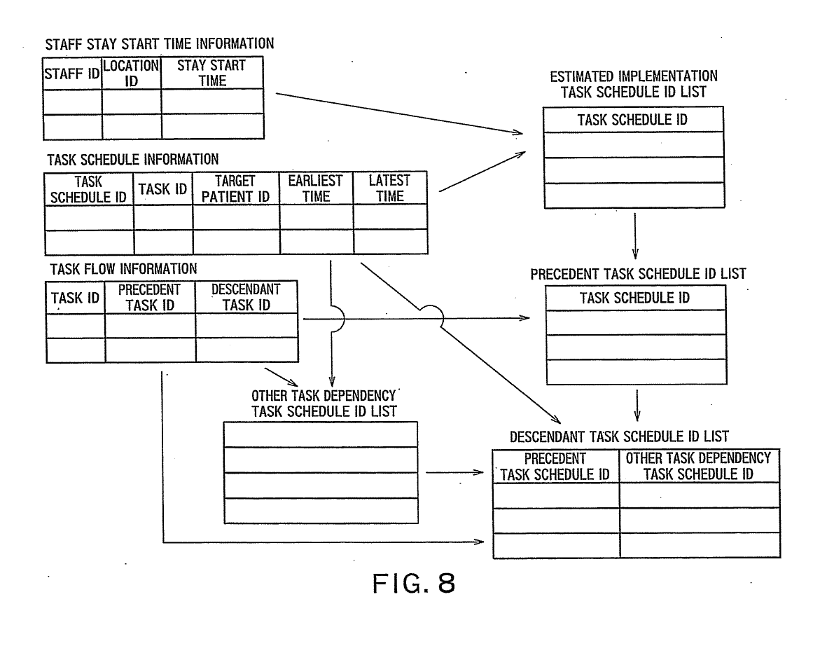

The first estimating unit 5, as depicted in FIG. 8, refers to the staff stay starting time information at the present time t, thereby obtaining the stay location s of each staff.

Subsequently, the first estimating unit 5 selects an estimated implementation task of the staff at the present time t from within the task schedule information of the staff. Specifically, a task specified by the time t included between the earliest time and the latest time, the already-implemented probability that is “0” (i.e., certainly not yet implemented) or equal to or smaller than the fixed value p and the implementation location that is given by “s”, is selected as the estimated implementation task of the staff. The first estimating unit 5 adds the task schedule ID of the selected task to the estimated implementation task schedule ID list. The status storage 15 retains the estimated implementation task schedule ID list.

Herein, there are K-pieces of estimated implementation task schedules for a certain staff at the time t, in which case an already-implemented probability Pₖ of each estimated implementation task schedule k(=1, 2, 3, . . . , K) can be calculated by, e.g., the Multi-Nominal Logistic Regression Model given as below.

$${p}_{k} = \frac{{e}^{{α}_{k} x}}{1 + {\sum }_{i = 1}^{K} {e}^{{α}_{i} x}} \\ x = ( 1 , {t}_{k} s - t , {t}_{k} e - t , p ( t ) , {a}_{x} ( t ) , {a}_{y} ( t ) , {a}_{z} ( t ) , voice ( t ) , IsEqual ( nearestPatientID ( t ) , {PatientID}_{k} ) ) )$$

Herein, variables etc contained in “x” have following meanings respectively, and all of the variables are not necessarily used. A symbol “α” denotes a vector of the same dimension as that of “x”, and a value of each element of “α” is calculated beforehand by the known method. Acceleration may be obtained by an image analysis, and a value of an accelerometer attached to the staff may also be acquired from the mobile terminal.

tₖs: the earliest time of scheduled task information k

tₖe: the latest time of scheduled task information k

p(t): the stay location of the staff at the time t

aₓ(t), a_{y}(t), a_{z}(t): the three—dimensional accelerations

(x—direction, y—direction, z—direction) with action of staff at the time t

voice(t): the word vector formed from voice of staff in fixed period of time before and after the time t being centered

nearestPatientID(t): the ID of patient nearest to staff at the time t

PatientIDₖ: the ID of therapy/medical examination target patient in scheduled task information k

IsEqual(X,Y): the function taking 1 if X=Y but taking 0 whereas if not

A symbol “voice(t)” is a word vector that is formed as follows. A word is extracted by a morphological analysis from a result of voice recognition of the staff within a fixed period of time before and after the time t. Held beforehand is an aggregation of words used in the post to which the user belongs. The words are sorted in the order of dictionaries and suffixed with numbers starting from 1 as below.

{w1, w2, w3, w4, w5, . . . , wN}={fever, body temperature, pulse, blood pressure, drip, oral administration, . . . , patient}

Herein, an i-th component is set to “1” if there is a word coincident with “wi” in a set of words extracted from a talk uttered by the staff within the fixed period of time based on the time t and is set to “0” whereas if not, thereby enabling the word vector voice(t) to be configured as follows.

voice(t)=(1, 0, 1, 1, 0, 0, 0, . . . , 0)

Supposing that the result of the voice recognition of the utterance of the staff is, e.g., “I'll measure the fever, the pulse and the blood pressure”, the word “fever” contained in this utterance is coincident with “w1”, the “pulse” is coincident with “w3” and the “blood pressure” is coincident with “w4” with the result that the first component, the third component and the fourth component become “1”, whereby the word vector is obtained. The dictionary can be changed over corresponding to user's attributes such as the job title (doctor, nurse, pharmacist) and the assignment post (surgery, internal medicine) of the user. Further, the words having relevancy in terms of content are grouped, and the group vector having groups as components may be configured. To be specific, supposed that there are the following settings;

g1={fever, body temperature, pulse, blood pressure, degree of saturation of blood oxygen} (words pertaining to vital measurement)

g2={drip, injection, . . . } (words pertaining to injection/drip)

g3={meal, breakfast, lunch, supper, serving trays of food, clearing dishes, . . . } (words pertaining to meal)

g4 . . . ,

if the word coincident with any one of components of “gi” is contained in the set of words, the i-th component of the group vector is set to “1” and if not, the i-th component of the group vector is set to “0”, thereby enabling the vector to be configured. Alternatively, the i-th component may be applied to a ratio of how many words in all of the words in “gi” are coincident with the words in the utterance. For instance, in the case of “I'll measure the fever, the pulse and the blood pressure”, the three words “fever”, “pulse” and “blood pressure” are coincident with the words in “g1”. The “g1” totally contains the five words, and hence a value “⅗=0.6” may be set as the first component of the group vector.

In addition to the Multi-Nominal Logistic Regression Model, the already-implemented probability of each estimated implementation task schedule can be also estimated by the Bayesian network, the hidden Markov model, etc.

Moreover, it is possible to calculate, absolutely in the same way, not only the already-implemented probability but also the implementation-underway probability (implementation-underway accuracy) qₖ indicating whether the implementation of each estimated implementation task schedule is underway or not and to generate and deliver the message to other staffs by use of the magnitude of the implementation-underway probability. For example, if the implementation-underway probability qₖ of a certain estimated implementation task schedule k abruptly increases over a fixed threshold value (e.g.,95%) at a certain point of time, it can be presumed that the estimated implementation task schedule k will have been started at that point of time. With this presumption, it is feasible to generate a message purporting that the staff starts the estimated implementation task schedule k and deliver this message to other staffs in a required range. For instance, the staffs for the descendant tasks, the supervisor of the staffs, etc can be considered as a category of those other staffs in the required range.

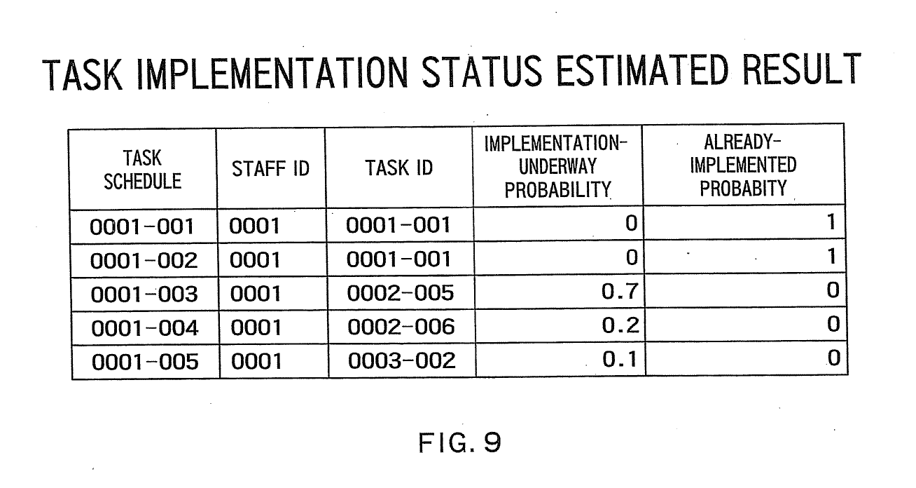

FIG. 9 illustrates an example of the task implementation status estimated result obtained by the first estimating unit 5.

[Generation of Precedent Task Schedule ID List: S102]

The first estimating unit 5 selects, as the precedent task schedule at the time t, the task schedule for which the descendant task ID exists, in the task schedules (data in the task schedule information) specified by the task schedule IDs in the estimated implementation task schedule ID list at the time t.

The determination as to whether the descendant task ID is contained or not may involve referring to the data of the task schedule in the task flow information table of the task information storage 3. The task schedule IDs of these selected precedent task schedules are added to the precedent task schedule ID list. The status storage 15 retains the precedent task schedule ID list.

[Generation of Another Task Dependent Task Schedule ID List: S103]

The first estimating unit 5 selects at the time t, as an another task dependent task schedule given at the time t, the task schedule for which the precedent task ID exists, among the task schedules (data in the task schedule information) of which the start time exists between the present time t and t+Δt after a fixed period of time with respect to the task schedules of all of the staffs. A check as to whether the precedent task ID is contained or not is made based on the task flow information table of the task information storage 3.

The task schedule ID of the selected another task dependent task schedule is added to the another task dependent task schedule ID list. The status storage 15 retains the another task dependent task schedule ID list.

[Generation of Descendant Task Schedule ID List: S104]

The first estimating unit 5 verifies whether or not both of the following relationships (1) and (2) are established at the time t with respect to a task schedule A (data in the task schedule information) specified by the task schedule ID in the precedent task schedule ID list and a task schedule B (data in the task schedule information) specified by the task schedule ID in the another task dependent task schedule ID list:
(1) The target patient ID of the task schedule A=the target patient ID of the task schedule B; and
(2) The descendant task ID of the task schedule A=the task ID of the task schedule B.

Note that the verification as to whether the following relationship (3), i.e., the precedent task ID of the task schedule B=the task ID of the task schedule A, may also be done in place of the relationship (2).

If established, the implementation of the task schedule A is underway (because the task schedule in the precedent task schedule ID list is a part of the estimated implementation task schedules), and it can be presumed that the task schedule B scheduled to start within the fixed period of time Δt since the present time t depends on completion of the task schedule A.

The first estimating unit 5 adds, to the descendant task schedule ID list, a 2-tuple of IDs, i.e., the task schedule ID in the precedent task schedule ID list and the task schedule ID of the another task dependent task schedule that depends on the task. The status storage 15 retains the descendant task schedule ID list.

Incidentally, it is not mandatory to generate the precedent task schedule ID list, the descendant task schedule ID list and the another task dependent task schedule ID list. The task precedent or descendant to a certain task schedule may be calculated each time the necessity arises by making use of the task flow information.

(Query Unit 6)

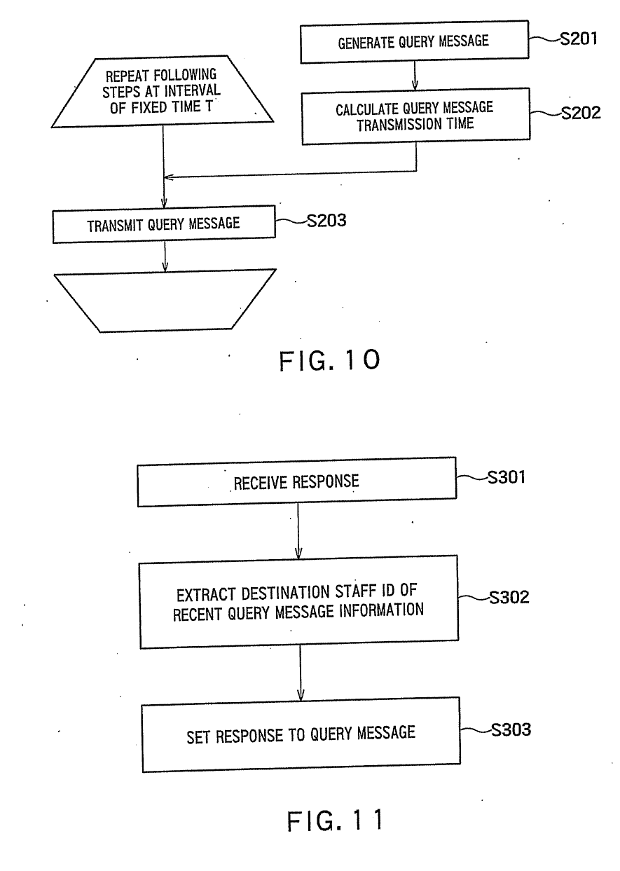

The query unit 6 operates according to a flowchart depicted in FIG. 10. Respective steps in the flowchart will hereinafter be described in detail. As discussed above, the query unit 6 includes a query message information storage, a query message generating unit, a query message transmission time calculator and a query message transmitting unit.

[Query Message Information Storage]

The query message information storage retains the query message information.

The query message information contains a query message ID, a query message, an estimated implementation task schedule ID, query message transmission time, a response and an already-transmitted flag (0: not yet transmitted, 1: already transmitted).

The query message is exemplified such as the text data, the voice data and the image data.

[Generation of Query Message: S201]

The query message generating unit generates, when the first estimating unit 5 newly adds the task schedule ID to the estimated implementation task schedule ID list at the present time t, the query message corresponding to a task content of the task schedule. Further, the query message ID is attached to the query message.

The query message generating unit generates the query message information containing the query message and the task schedule ID (estimated implementation task schedule ID) of the relevant task schedule, and transmits the query message information to the query message information storage. The query message information storage retains this query message information. At this point of time, the query message transmission time, the response and the already-transmitted flag are not yet described in the query message.

The query message may be set as, e.g., what follows. To be specific, let a be a task flow name of the estimated implementation task schedule A and b be a task name. At this time, the query message may be edited such as: “Is the task name b in the task flow name a finished?”.

Herein, the task schedule, at which the query message generating unit generates the query message targeted, may be set to only the task schedule for which the descendant task schedule exists among the estimated implementation task schedules at the time t (i.e., the task schedule specified by the task schedule ID in the precedent task schedule ID list at the time t).

[Calculation of Query Message Transmission Time: S202]

A query message transmission time calculator calculates the query message transmission time with respect to each piece of query message information, and sets this transmission time in the query message information.

Specifically, the query message transmission time calculator at first refers to the staff stay starting time information stored by the staff location history storage 4, thus obtaining the stay stating time ts in the present location s.

Subsequently, the query message transmission time calculator calculates query message transmission time: ts+T+Nσ (N=1, 2, 3 . . . ) in a manner that refers to average implementation time T of the task and a standard deviation a thereof by using the task information table from the task ID of the task schedule specified by the estimated implementation task schedule ID of the query message information. Herein, “N” may be set to a proper natural number.

If the staff has a single estimated implementation task schedule, it can be presumed that the task concerned will have been started at the time ts in the location s. Assuming that a distribution of the task implementation time is a normal distribution, statistically a probability that the task will have been completed before “T+σ” is, it can be considered, approximately 84% and a probability that the task will have been completed before “T+2σ” is, it can be considered, approximately 98%. If there are k-pieces (k≧2) of estimated implementation tasks, it follows that the query is made k-times.

[Transmission of Query Message: S203]

The query message transmitting unit selects, at an interval of a fixed period of time T, the data containing the already-transmitted flag set to “0” and the message transmission time that coincides with the present time (alternatively a difference therebetween is equal to or smaller than the fixed period of time) from within the pieces of data of the query message information. Then, the query message transmitting unit transmits the thus-selected query message to the mobile terminal held by the staff specified by the staff-in-charge ID of the task schedule specified by the estimated implementation task schedule ID. The message information is transmitted in the form of a voice message, a text message or image data. Upon completing the transmission, the already-transmitted flag of the query message information is set to “1”.

(Response Receiving Unit 7)

The response receiving unit 7 operates based on a flowchart in FIG. 11. The following is an in-depth description of respective steps in the flowchart.

[Reception of Response: S301]

A received response is associated with response reception time. If response transmission time, is given by the mobile terminal 11 serving as a response sender to the response, the response transmission time may be used as a substitute for the response reception time.

[Extraction of Sender Staff ID in Recent Query Message Information: S302]

The response receiving unit 7 refers to the task schedule by employing the estimated implementation task schedule ID contained in the query message information, thus obtaining the query message sender staff ID. On this occasion, it may elect the query message information whose transmission time is any time after a fixed period of time ago than the response reception time from within pieces of query message information, and set only this selected query message information as a target.

[Setting of Response to Query Message: S303]

Subsequently, the response transmission staff ID specifiable by the mobile terminal ID of the response sender is collated with the staff ID of the query message recipient, then the query message information is associated with the response, and a content of this response is set as the response data to the associated query message information.

The response data may be any one of the text data, the voice data and the image data. The text data may be a comment that is described directly by the staff and may also be data representing contents of actions (click, touch) of the staff. with respect to a “Yes/No” button displayed on the mobile terminal.

Demonstrated above is the mode in which the response receiving unit 7 receives the response to the query message, however, the response receiving unit 7 may receive a voluntary message (such as a task “X” on the patient A is finished“) of the staff from the mobile terminal 11. In this case, the processes in steps S302, S303 are not required.

(Operation of Second Estimating Unit)

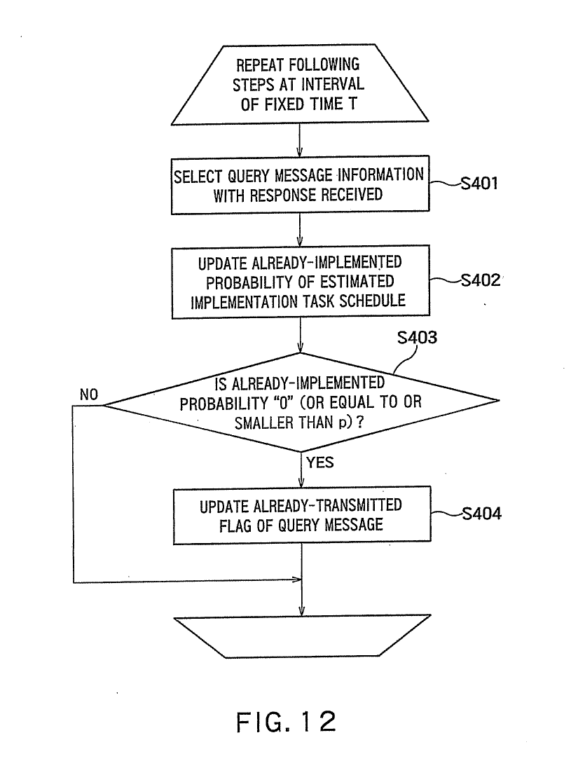

The second estimating unit 8 operates according to a flowchart in FIG. 12. The following is an in-depth description of the respective steps in the flowchart.

[Selection of Query Message Information with Already-Received Response: S401]

The second estimating unit 8 selects, from within pieces of query message information, the query message information for which the response is set and the already-implemented probability of the task schedule specified by the estimated implementation task schedule ID is set to “0” (alternatively equal to or smaller than a fixed value p), as “the query message information with the already-received response.”

[Update of Already-Implemented Probability of Estimated Implementation Task Schedule: S402]

The second estimating unit 8 estimates the already-implemented probability and the implementation-underway probability in accordance with the content of the response with respect to the task schedule specified by the estimated implementation task schedule ID of the selected query message information with the already-received response. Then, if an estimated result is larger than the already-implemented probability of the task schedule at that point of time, the second estimating unit 8 updates the already-implemented probability and the implementation-underway probability of the task schedule in the task implementation status estimated result. Further, the second estimating unit 8 updates the already-implemented probability in the task schedule with the same value.

For instance, if the response from the staff A with respect to the query message “Is “b” of “a” finished?” given to the staff A is “Yes” or “It's finished”, a presumption is that the staff A will have completed the task b of the task flow a, and the value of the already-implemented probability is set to “1”.

Whereas if the response is “No” or “It's not yet finished” or “It takes a little bit longer”, the presumption is that the staff A will have not yet completed the task b, and the value of the already-implemented probability is set to “0”. The already-implemented probability may be calculated as the value within a range of “0” to “1” corresponding to the content of the response.

Note that the already-implemented probability is estimated corresponding to the content of the response to the query, however, if the response receiving unit 7 receives not the response but the voluntary message of the staff, the same process may be executed based on a content of this voluntary message.

The implementation-underway probability can be likewise calculated and updated corresponding to the content of the response.

[Update of Already-Transmitted Flag of Query Message: S403, S404]

Herein, if the already-implemented probability is “0” or equal to or smaller than the fixed value p, the second estimating unit 8 may set the value of the already-transmitted flag of the query message information back to “0”, and may reset the query message transmission time to the time t+Δt after the fixed time Δt since the present time t. With this setting, the query message is retransmitted at the time t+Δt to the mobile terminal 11 held by the staff in charge of the implementation of the task schedule.

(Task Progress Status Notifier 9)

The task progress status notifier 9 selects the task schedule of which the already-implemented probability is “1” or equal to or larger than the fixed value from within the task schedules specified by the task schedule IDs in the estimated implementation task schedule ID list (or the precedent task schedule ID list), and generates a message for conveying a purport that the implementation of the task schedule has been completed.

The task progress status notifier 9 transmits the generated message to the mobile terminal 11 held by the staff-in-charge specified by the staff-in-charge ID in the task schedule with respect to the task schedule specified by the task schedule ID in the descendant task schedule ID list.

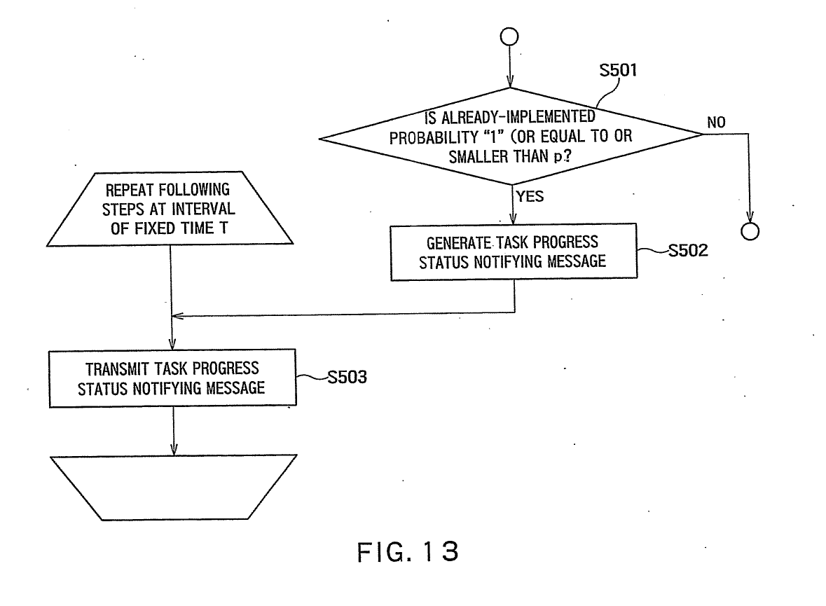

The task progress status notifier 9 includes a task progress status notifying message information storage, a task progress status notifying message generator and a task progress status notifying message transmitter. FIG. 13 illustrates an operation flow of the task progress status notifier 9.

[Task Progress Status Notifying Message Information Storage]

The task progress status notifying message information contains a “task progress status notifying message ID” field, a “task schedule ID” field, a “task progress status notifying message” field (which will be described later on) and an “already-transmitted flag (0: not yet transmitted, 1: already transmitted)” field.

[Generation of Task Progress Status Notifying Message: S501, S502]

The task progress status notifier 9, if the already-implemented probability estimated by the first estimating unit 5 is “1” (alternatively equal to or larger than the fixed value p), or if the second estimating unit 8 updates the already-implemented probability of a certain task schedule to “1” (alternatively a value equal to or larger than the fixed value p), generates the task progress status notifying message for conveying a purport that the implementation of the task schedule has been completed.

The task progress status notifying message may be, for example, formed as below. To be specific, the task flow name of the task schedule is set to “a”, and the task name is set to “b”. At this time, the task progress status notifying message may be formed such as “b of a is finished”. The task progress status notifying message may take any one of formats such as the text data, the voice data the image data.

The task progress status notifying message generator generates the task progress status notifying message information containing the task progress status notifying message and having the already-transmitted flag that is set to “0”. The generated task progress status notifying message information is stored by the task progress status notifying message information storage.

[Transmission of Task Progress Status Notifying Message: S503]

The task progress status notifying message transmitter specifies the task progress status notifying message information in which the already-transmitted flag is set to “0” in pieces of task progress status notifying message information stored by the task progress status notifying message information storage. Then, the task progress status notifying message transmitter refers to the descendant task schedule list for the task schedule in the specified task progress status notifying message information, and transmits the task progress status notifying message to the mobile terminal 11 held by the, staff specified by the staff-in-charge ID of the task schedule specified by the descendant task schedule ID.

The task progress status notifying message may take any one of the formats such as the text data, the voice data and the image data. The task progress status notifying message transmitter, upon completing the transmission, sets the already-transmitted flag to “1”.

Before transmitting the task progress status notifying message, only when the staff recites the content of the message and replies the acknowledgement, this message may be transmitted to other staffs.

An available scheme is that the message data are stored on the tweet data storage 13 in the way of being associated with the staff ID and the present time and are browsed by the tweet data browsing unit 14.

### Second Embodiment

A second embodiment will discuss how the estimated implementation task schedule ID list using the information excluding the stay location is generated.

The RFID tag is fitted to the patient or installed on the bed of each patient, in which case it might be feasible to acquire the information about which patient the staff approaches at every point of time.

Further, the RFID tag is installed at each medical instrument, in which case it might be possible to acquire the information about which medical instrument the staff approaches at every point of time.

Still further, it might happen that the staff ID is specified when using the medical instrument, in which case a time-based usage history of every medical instrument by the staff can be acquired.

In such a case, when generating the estimated implementation task schedule ID list described above, a patient approach information history, a medical instrument approach information history and a medical instrument usage history are stored in association with a staff location information history, whereby the first estimating unit 5 can narrow down the estimated implementation task schedule more precisely by employing these categories of history information.

### Third Embodiment

[Calculation of Query Message Transmission Time Corresponding to Estimated Implementation Sequence of Descendant Task schedule]

The calculation of the query message transmission time described above may involve taking the following method. Specifically, with respect to the task schedules of all the staffs during the period from the present time t up to the time t+Δt after the fixed time Δt, the query message transmission time is determined on the assumption that each staff implements the task most efficiently.

Supposing that the implementation time of the sole task does not depend on a task implementation sequence and all the precedent tasks will have been completed, the most efficient task implementation sequence is a sequence in which the tasks are implemented to minimize a moving distance from the position s. The first estimating unit 5 obtains such a task implementation sequence as an estimated implementation sequence for a time zone [t, t+Δt] at the time t.

If a plurality of task schedules is implemented by a certain staff for the time zone [t, t+Δt] at the same location, the implementation sequence of those task is set arbitrary.

It is assumed that the estimated implementation sequence for the time zone [t, t+Δt] of the staff A is given such as g1, g2, . . . , g(i-1), gi, . . . , gn, and the implementation period of time of each task schedule gi is pursuant to an average Ti and a normal distribution of a standard deviation σi. Based on this estimated implementation sequence, a sum of periods of implementation time of the task schedules g1, g2, . . . , g(i-1) is pursuant to the normal distribution of an average

$${\sum }_{k = 1}^{i - 1} Tk$$

and a normal distribution of a standard deviation

$${\sum }_{k = 1}^{i - 1} σ k .$$

Accordingly, on the basis of this estimated implementation sequence, it is considered that the task gi is started after completing the task schedules g1, g2, . . . , g(i-1), and hence it can be presumed that the task gi is started at the time

$$t + {\sum }_{k = 1}^{i - 1} Tk + d ( s ( i - 1 ) ,$$

si) on the average.

Herein, s(i-1) denotes the implementation location of the task schedule g(i-1), si represents the implementation location of the task schedule gi, and d(s(i-1), s) designates average requirement time of the movement from the location s(i-1) up to the location si. This information is acquired from inter-location average movement requirement time information stored on an in-building location information storage which will be described later on. The start time of the task schedule descendant to each precedent task schedule can be thereby estimated, and therefore the time, which is a fixed period of time before the estimated start time, may be set as the query message transmission time of the precedent task schedule.

[In-Building Location Information Storage]

As discussed above, the first estimating unit 5 refers to in-building location information and inter-location average movement requirement time information in the case of using the average movement requirement time between the task implementation locations to estimate the estimated implementation sequence.

[In-Building Location Information]

Stored are names of locations and location IDs of specified locations (such as a patient bedroom, an examination room and a nurse center of every floor) in the building.

[Inter-Location Average Movement Requirement Time Information]

Stored is a distance between two locations with respect to an arbitrary 2-tuple of locations in the building, or an average movement requirement time obtained by dividing the distance by an average movement speed.

### Fourth Embodiment

The query message described above may be transmitted as follows. To be specific, the query message transmitting unit of the query unit 6 selects the query message information of which the already-transmitted flag in each record of data is set to “0” from pieces of query message information at an interval of a fixed period of time T.

Then, the present location ID of the staff is acquired by using the staff ID and the staff location history information with respect to the task schedule specified by the estimated implementation task schedule ID registered in the selected query message information.

If the acquired present location ID is different from the implementation location ID of the task schedule, it is determined that the staff concerned has already completed the task schedule and moved to another location, and the query message is transmitted to the mobile terminal 11 of this staff.

Whereas if the acquired present location ID is coincident with the implementation location ID of the task schedule, it is determined that the staff concerned does not yet complete the task schedule, and the transmission of the query message remains in a standby status.

### Specific Examples

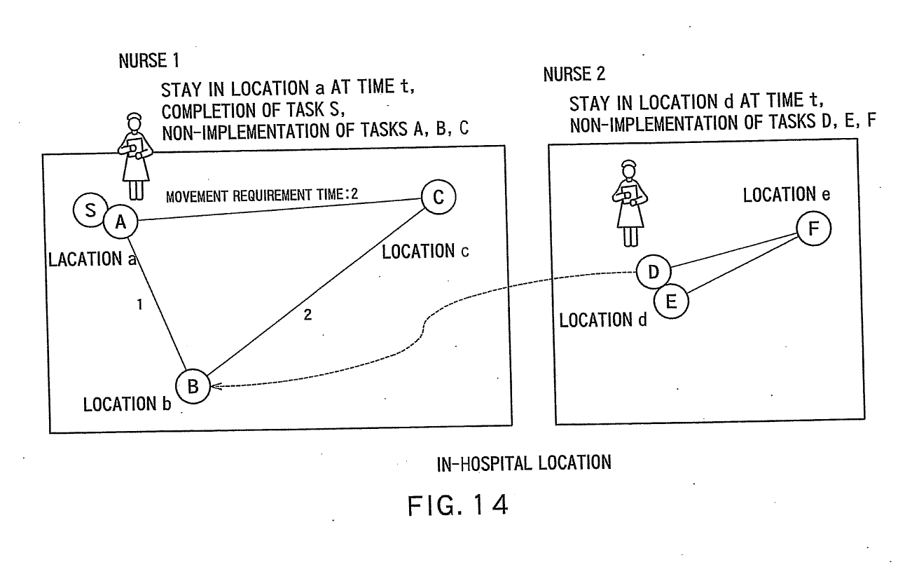

As illustrated in FIG. 14, an assumption is that two nurses implement the tasks in parallel and each nurse has a plurality of not-yet-implemented task schedules. It is presumed that a nurse 1 stays in the location a at the time t, and task schedules A, B, C scheduled to be done till the time t+Δt are not yet implemented. It is also presumed that a nurse 2 stays in the location d at the time t, and task schedules D, E, F scheduled to be done till the time t+Δt are not yet implemented.

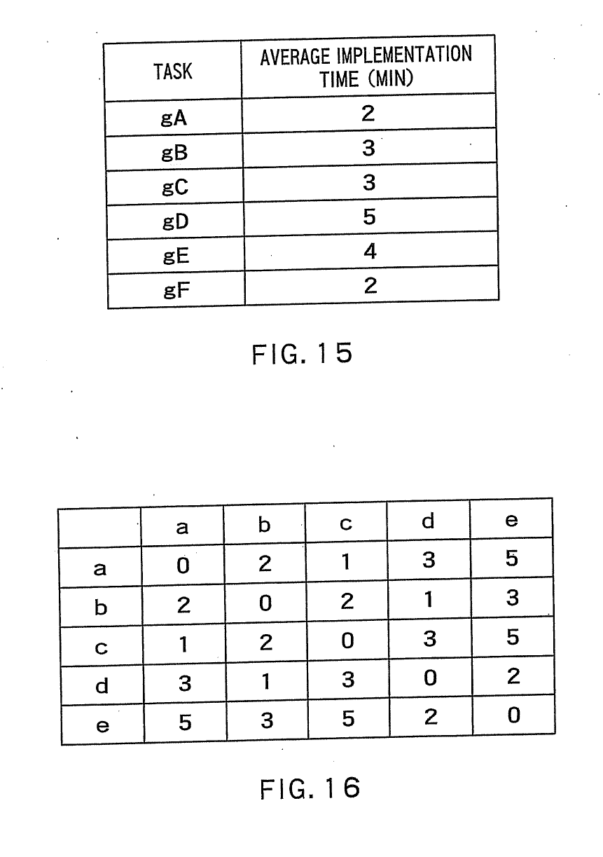

Herein, the schedule B in the task schedules of the nurse 1 is based on a premise that the implementation of the task schedule D of the nurse 2 is completed. Further, the average implementation time of the tasks gA-gE specified by the task schedules A-E is to be given in FIG. 15. Moreover, the average movement requirement time between the two locations is to be given in FIG. 16.

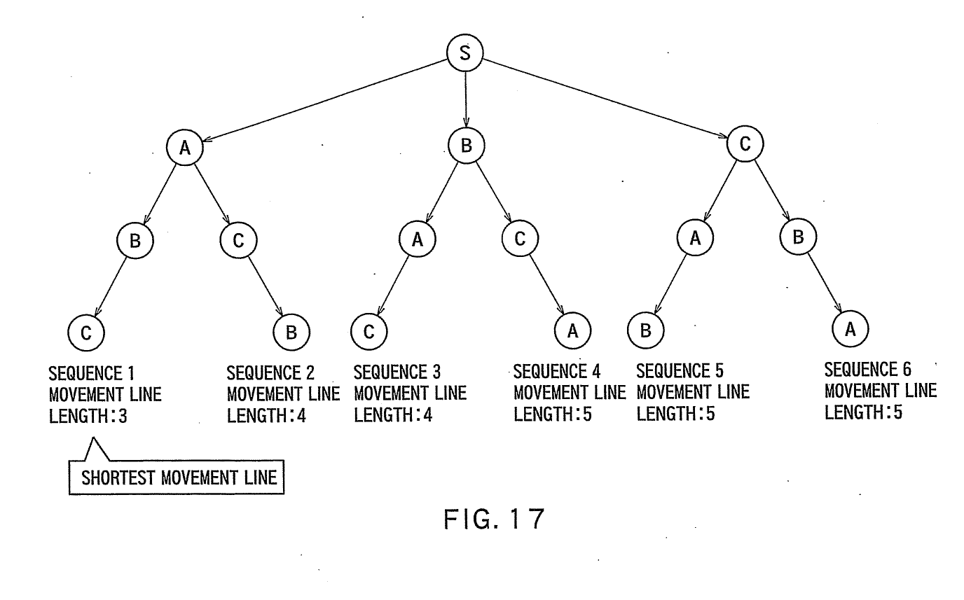

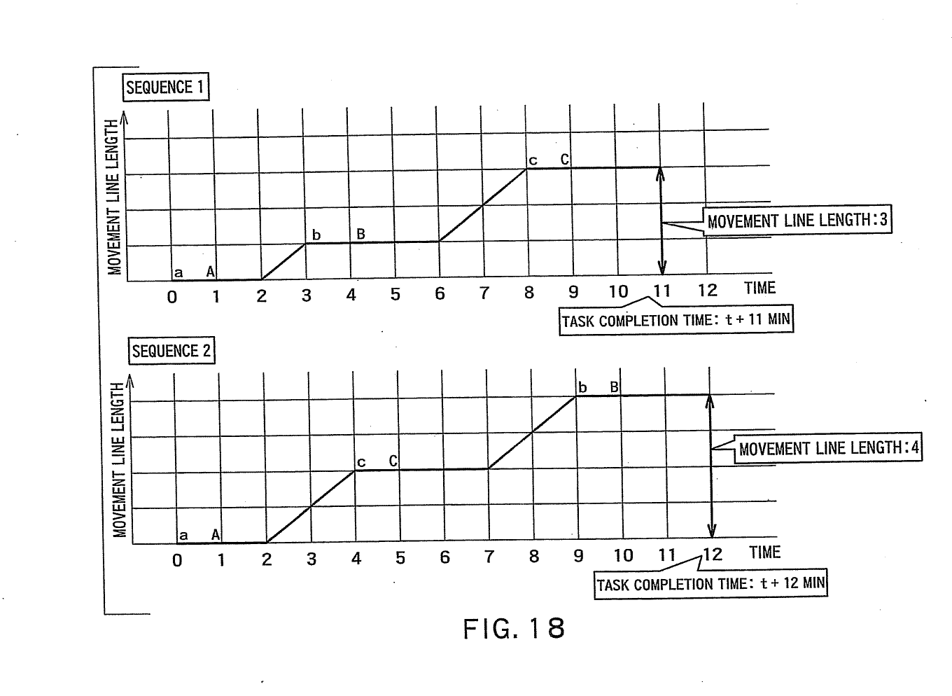

The task schedule implementation sequence of the nurse 1 includes the sequences 1-6 depicted in FIG. 17, in which the sequence 1 has the minimum line length of movement. Supposing that the implementation time period of the sole task does not depend on the task implementation sequence but is fixed and that the task D of the nurse 2 will have been implemented at a point of time when implementing the task B, the sequence for completing all the not-yet-implemented task schedules at the shortest length is the sequence 1. FIG. 18 depicts the movement line length and the task schedule implementation completion time of each of the sequences 1 and 2.

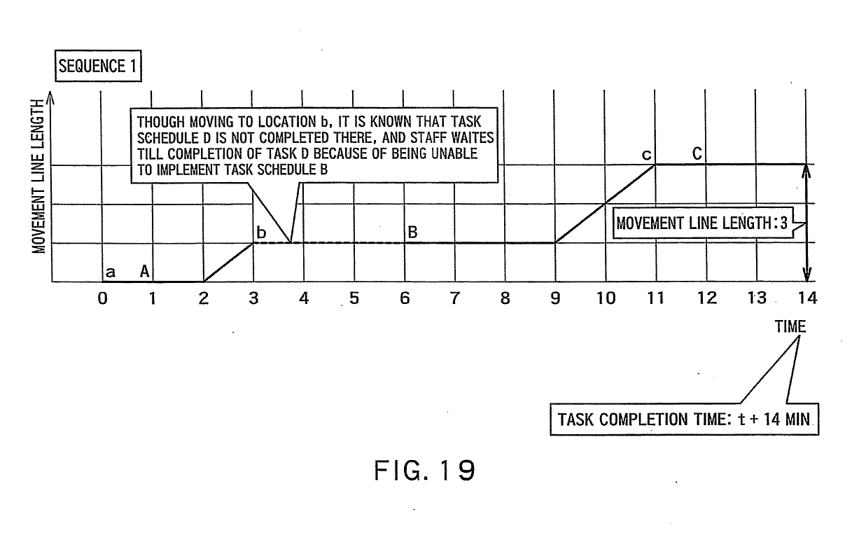

Presuming, for instance, that the nurse 2 implements the tasks in the task schedule sequence “E→D” at the location e, however, it takes 6 minutes given by 4 min+2 min=6 min on the average, and hence the task D is not completed up to the time 6 on the average. In this case, if the nurse 1 implements the task schedule in the sequence 1, as illustrated in FIG. 19, the nurse 1 has to wait for 3 min up to the time t+6 min to implement the task B, and the task completion time of the nurse 1 turns out to be “t+14 min”, resulting in deterioration in efficiency due to a 3-min delay.

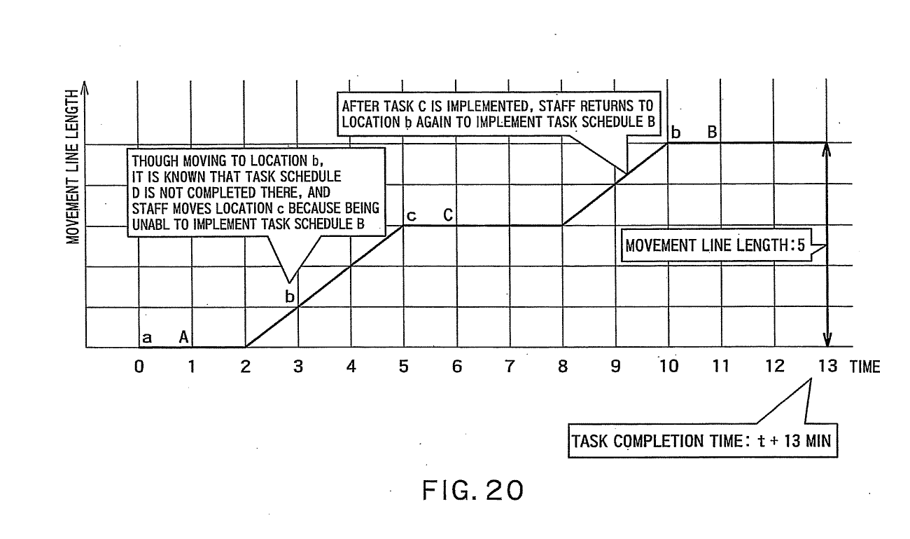

Furthermore, as depicted in FIG. 20, it proves that the nurse 1 does not yet complete the task schedule D since moving to the location b after completing the implementation of the task schedule A. Then, in the case that the nurse 1 implements the task schedule C by moving to the location c, and thereafter implements the task schedule B by returning to the location b, the task completion time of the nurse 1 turns out “t+13 min”, and the movement line length becomes “5”, resulting in the deterioration in efficiency.

In such a case, when employing the system according to the embodiment, the nurse 1 selects, if knowing that the task D has been completed at the time “t+2” at when the task A completed, the sequence 1 exhibiting the highest efficiency. If not notified of the completion of the task D, it is determined that the task D is not completed, the task can be finished at the time “t+12 min” by selecting the sequence 2 in FIG. 19 (FIG. 16). Accordingly, as compared with the two cases (FIGS. 19 and 20, the task schedule can be implemented at the high efficiency in terms of the task implementation time and the movement line length as well.

### Fifth Embodiment

### Voice Tweet Browse Function

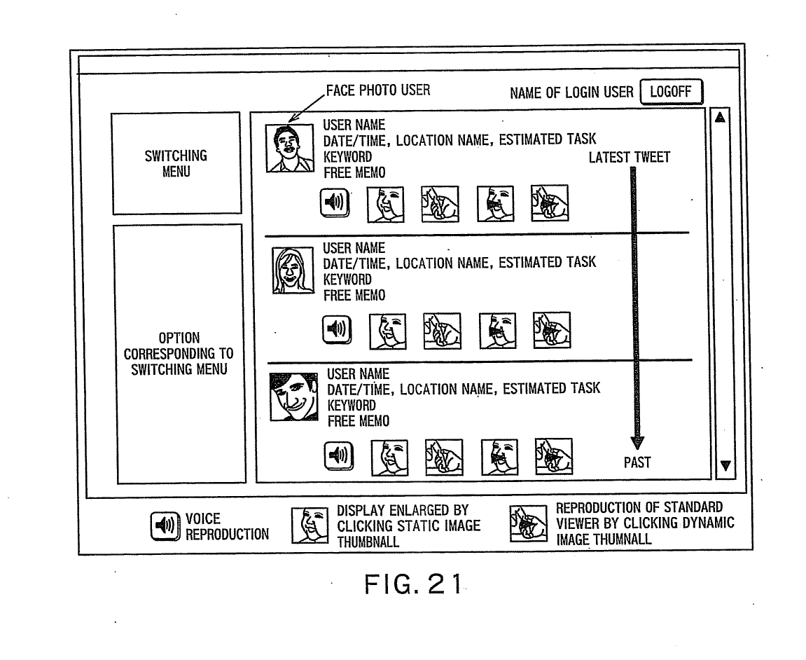

When opening a tweet data browse page (Web page etc) as in FIG. 21 via the tweet data browsing unit 14 from on the mobile terminal 11 or a PC (Personal Computer) of the staff, tweet data registered in a DB (database) (tweet data storage 13) is displayed on the page. When opening the browse page

(Web page etc), the user (nurse) logs in by specifying (inputting) the staff ID.

Contents of the display are:
user name on the user master (user database), which is associated with the user ID in the tweet data;
date/time: year/month/day hour:minute;
location name: the location name on the location master (location database), which is associated with the location ID in the tweet data;
estimated task name: the task name in the schedule on the schedule data, which is specified by the estimation schedule ID in the tweet data;
keyword: the keyword in the tweet data;
free memo: the free memo in the tweet data;
voice data icon: the voice data of the tweet data are reproduced when clicking the icon;
static image thumbnail: the static image data of the tweet data are displayed; and
dynamic image thumbnail: the dynamic image data of the tweet data are reproduced.

On the tweet data browse page, the tweet data can be displayed in the way of being switched over based on a variety of viewpoints such as the points 1-5.

1. Menu Time-Series Display (As in FIG. 21)

A display format is the default browse format shared with all the login users. As in Twitter, the tweet data are displayed in time-series according to the date/time of the tweet data. As for the date/time of the sweet data, the display target data can be narrowed down in all categories such as the very day (within 24 hours), within one week and within one month. The default is set on the very day (within 24 hours). In the following also, the tweet data can be similarly narrowed down according to the date/time.

2. Display of Tweet List of Members of Specified Post

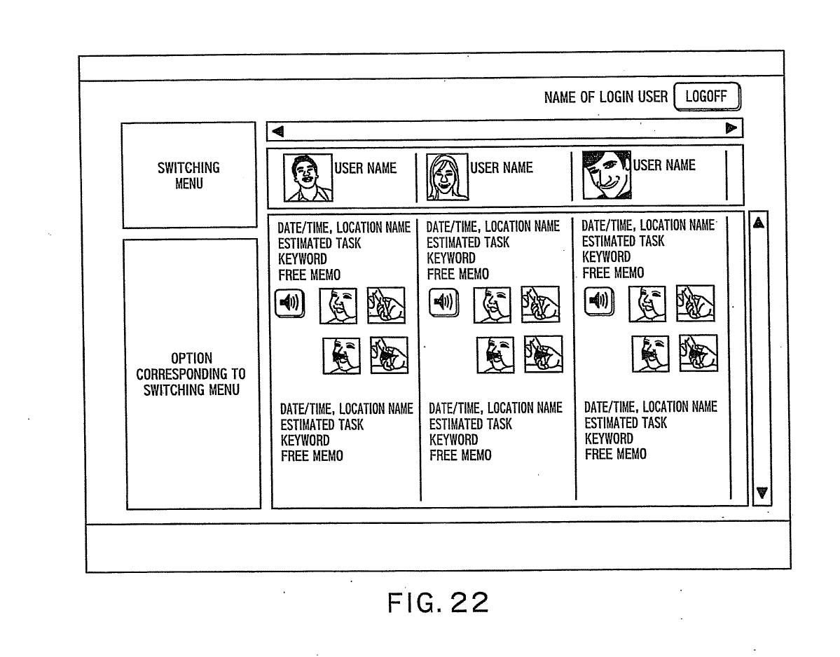

Any one of the posts on the post master (post database) can be selected. When selected, as specified by an attribute “1-ID” on the user master (user database), the tweet data of the users belonging to the selected post are displayed as in FIG. 22 in a descending sequence of time in the vertical direction while displaying the users in the row direction.

3. Display Of Tweet List of Specified Service Target Persons (Who are Herein Patients)

The tweet data belonging to the service target persons specified by the estimation service target person IDs are extracted from within pieces of tweet data and displayed in the descending sequence of time in the vertical direction.

4. Display of Tweet List of Other Users (Plural Users) Whom Login Users Want to Follow

The tweets of other users within a follower list of every login user are displayed. A display mode is that the users are arranged in the crosswise direction (row direction) similarly to the display mode 2 described above, and the descending sequence of time is displayed in the vertical direction. It is required that the follower list of every login user can be created and saved. The follower list may take a table format or a CSV (Comma-Separated Values) file format on the DB.

5. Display of Tweet List about Related Tasks of Login User's Schedule Task on Very Day

With respect to each record of schedule data of the login user on the very data, the tweet data related to the schedule data are extracted (an extraction method is given as below), in which the task names of the schedule data are displayed (arranged from left to right in a schedule start schedule time sequence) in the crosswise direction, while the time is displayed in the descending sequence. Let herein x be the schedule data of the login user on the very day, and the tweet data related to the schedule data x are the data extracted as follows:

“select * from tweet data table where estimated task ID in (select precedent task ID from task master where task ID=x.task ID) AND estimation service target person ID=x.service target ID”

[Configurations of Masters Etc]

The masters are defined as tables or CSV files on the database (DB).

User Master

The user master contains fields such as a user ID, a user name, an attribute 1-ID (job title) and an attribute 2-ID (post).
§ If necessary, the user master contains a “file path” field to a user face photo file as given below. A storage folder of the face photo file is set fixed, and the user ID is attached to a face photo file name, whereby the file path to the user's face photo file may not be provided on the user master.
§ The attribute 1-ID specifies the ID defined herein on the job title master.
§ The attribute 2-ID specifies the ID defined herein on the post master.

User's Face Photo Data (PNG (Portable Network Graphics) file etc)

Job Title Master

The job title master contains fields such as a job title ID and a job title name.

Service Target Master

The service target master contains fields such as a service target person ID and a name of service target person.

Post Master

The post master contains fields such as a post ID and a post name.

Location Master

The location master contains a location ID (access point ID on a wireless LAN (Local Area Network)) and a location name.

Task Master (Key: Task ID)

The task master contains fields such as a task ID, a task name, a taskwork ID, a precedent task ID and a descendant task ID.

Taskwork Master

The taskwork master contains fields such as a taskwork ID and a taskwork name.

Schedule Data (Master) (Key: Schedule ID)

The schedule master contains fields such as a schedule ID, a user ID, a task ID, a service target person ID, start schedule date/time, end schedule date/time, an implementation location ID, a precedent schedule ID and a descendant schedule ID.

### Sixth Embodiment

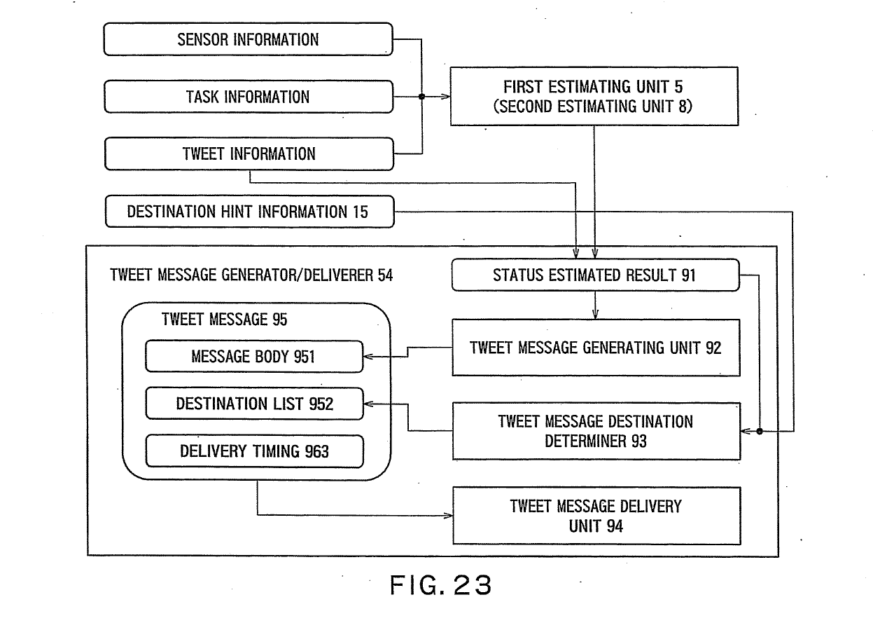

A sixth embodiment has a large feature in configuration of the tweet message generator/deliverer 54 in FIG. 1. FIG. 23 depicts a detailed configuration of the tweet message generator/deliverer 54 in the sixth embodiment.

The first estimating unit 5 (and the second estimating unit 8, which is not, however, a prerequisite herein) at first generates a status estimated result 91 from items of sensor information (location information, acceleration information, image information), task information and tweet information. Note that the sensor information and the tweet information are received by the sensor data receiving unit 51 and stored on the status storage 53 in FIG. 1, and the task information is stored on the task information storage 52 in FIG. 1.

A tweet message generating unit 92 generates a tweet message body 951 from the status estimated result 91 and the tweet information. For example, a tweet message “#the examination of the patient A has just started in the endoscopy room” by adding a necessary piece of information in a way that uses the status estimated result (place: endoscopy room, patient: A) from, e.g., a piece of tweet information “#It has just started” (which is the same information complementary function as the function of the task progress status notifier 9 in the first embodiment). Note that the tweet information may be an arbitrary piece of information such as a stage of progress (delay, advancement) of the task, notification of awareness, notification of a message in addition to the completion and the start of the task.

A tweet message destination determiner 93 generates, in parallel with this process, a destination list 952 from the status estimated result 91 and destination hint information 15 in which a delivery purpose is described on a per-task basis and on a per-implementation-status basis.

A tweet message delivering unit 94 delivers the generated tweet message body 951 to the destination in a destination list 952 at delivery timing 953.

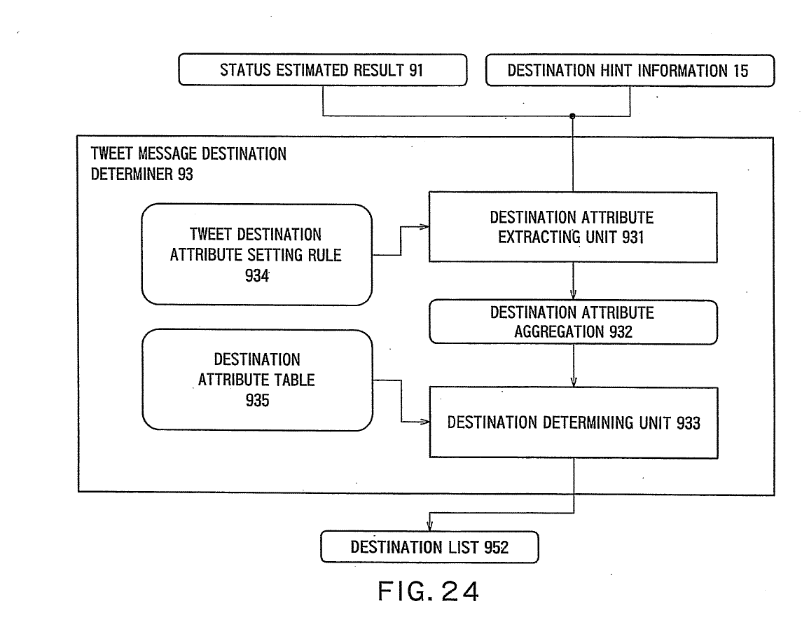

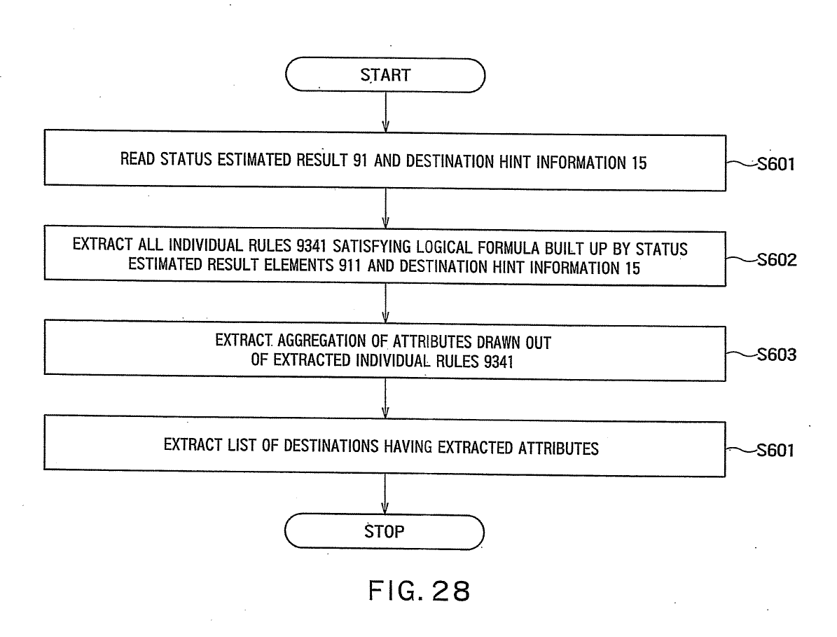

FIG. 24 depicts a detailed configuration of the tweet message destination determiner 93. FIG. 28 shows an operation flow of the tweet message destination determiner 93.

The tweet message destination determiner 93, to begin with, reads the status estimated result 91 and the destination hint information 15 (step S601).

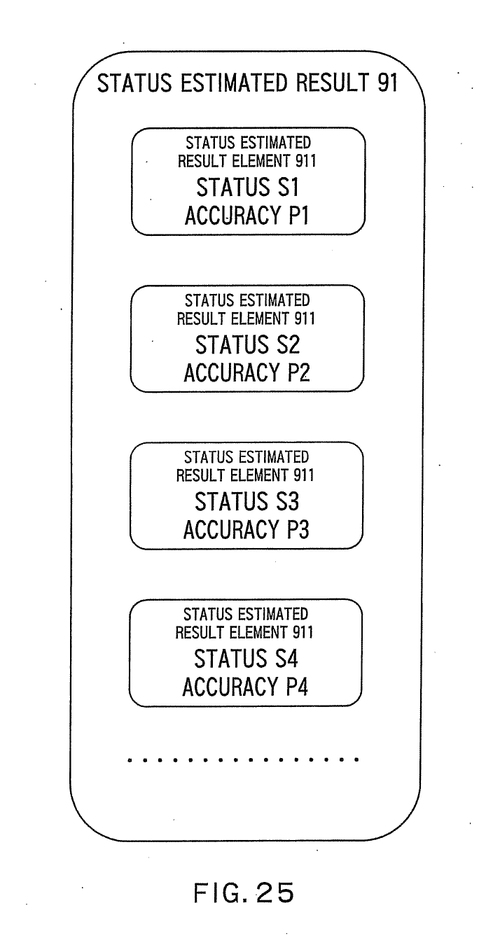

The status estimated result 91 includes a plurality of accuracy-attached status estimated result elements 911 (example: “start of examination (0.7), start of meal (0.3), treatment corresponding to change in patient's state (0.1)”) as depicted in FIG. 25. The plurality of accuracy-attached status estimated result elements is generated if the estimating unit cannot uniquely specify the status with uncertainty being left (if the accuracy of the estimated task and the implementation status are equal to smaller than a threshold value), and the task(s) and the predetermined implementation status with the accuracy being equal to or higher than the fixed value are selected. The fixed value is, for example, smaller than the threshold value. If there is no uncertainty, the selected item is single. Note that the accuracy may be calculated, similarly to the first embodiment, by using methods such as the multivalued logistic regression model and, in addition to the multivalued logistic regression model, the Bayesian network or the hidden Markov model. As to the implementation statuses, a variety of predetermined implementation statuses such as “started”, “completed”, and “implementation-underway” are specified, and the accuracy is calculated on the per-task basis and the per-predetermined-implementation-status basis.

The destination hint information 15, which is given intentionally by the user, is additional information for selecting the destination (recipient) more properly. For example, the destination hint information 15 is given by the user through a touch panel menu or a voice command from on the mobile terminal 11. The additional information contains descriptions of delivery purposes such as “report”, “urgent”, “share”, “notification” and “record”. A boss is selected as the destination in the case of “report”, and the user himself or herself is selected as the destination in the case of “record”. Note that the destination hint information 15 is not the prerequisite.

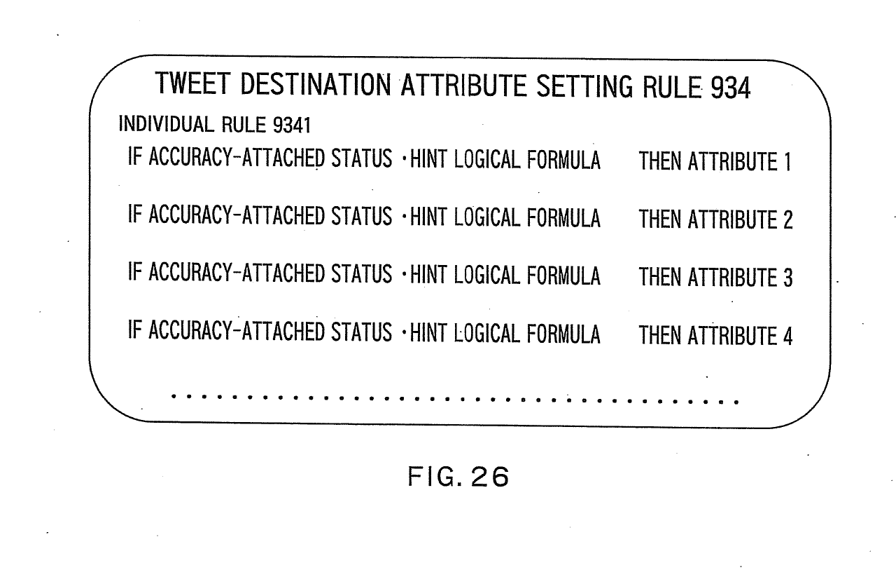

Next, as shown in FIG. 26, a process is executed, which uses a tweet destination attribute selection rule 934 including a plurality of individual rules 9341. Each individual rule contains a logical formula (IF part: if_part) built up by each of the status estimated result elements 911 and the destination hint information 15, and an attribute (THEN part: then_part). The attribute is used for determining the destination. All the individual rules satisfying the logical formula among these individual rules are extracted (step S602).

Herein, the accuracy is taken into consideration for extracting the attribute in the IF part of the rule. For example, in the case of “start of meal (0.3), treatment corresponding to change in patient's state (0.1)”, with respect to the attributes exhibiting the high urgency though low of the accuracy of the treatment corresponding to change in patient's state, the destination (recipient) is extracted on the safe side. The rules are exemplified as below. Note that the destination hint information is not used in this example.

Example: IF Start of Meal (Accuracy>0.7) THEN Attribute: Nurse Center

IF Treatment Corresponding to Change in Patient's State (Accuracy>0.1) THEN Attribute: Urgent Notification Network

Further, an aggregation of attributes described in THEN parts of the extracted individual rules 9341 is extracted (step S603). Herein, if there is the plurality of accuracy-attached status estimated result elements due to the uncertainty, the attributes are extracted by OR (logical sum) with respect to both of the possibilities. If there is the possibility of having a necessity for the delivery to a plurality of destinations, this is a scheme that the information is sent to all the destinations (recipients).

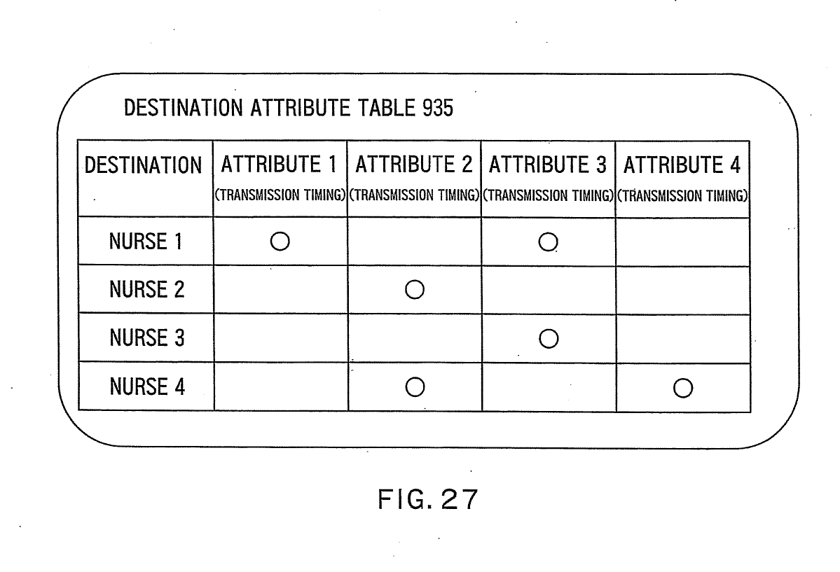

Finally, a list of the destinations having the extracted attributes is generated by use of a destination attribute table 935 as illustrated in FIG. 27 (step S604). Furthermore, the delivery timing 953 (see FIG. 23) is set in each attribute, and the delivery is performed at the timing 953.
Example of Attribute:

Attribute: urgent notifying network
Timing: immediate
Destination: chielf of nurses, doctor in charge, nurse in charge,
nurse center display board

Attribute: normal in-charge notification network
Timing: when moving and staying at nurse center
Destination: doctor in charge, nurse in charge, nurse center
display board

Attribute: record
Timing: when staying at nurse center
Destination: user himself or herself

### Effects of Embodiment

The mobile phone and the PHS (Personal Handyphone System) have hitherto been employed for the notification at the hospital, the nursing facility, the shop, the maintenance site and the construction site. In the behavior pattern service, it is time-consuming to input the telephone number and the mail address, which interrupts the job on the reception side in the case of the telephone call, and these pieces of equipment are not available for the elaborate and real-time notification in reality. By contrast, a broadcasting type wireless communication device called “Intercommunication” (which is a jargon of the hands-free communication device) has spread in the hospital, the nursing facility and the shop over the recent years. The hands-free communication device is, though capable of selecting the channel, basically directed to the broadcast (simultaneous multi-destination delivery) to all the members belonging to one channel but is disabled from designating the destinations depending on the status and content. This system can support a fewer member case but causes the difficulty in a many member case.

According to the present embodiment, the tweet message can be delivered at the proper timing to the proper person on the basis of the status estimation and the hint, and can innovatively improve the communications for the behavior pattern service at the hospital, the nursing facility, the shop, the maintenance site and the construction site. The proper message can be delivered particularly even in such a case that the uncertainty exists in the status estimation.

The task coordination support system of this embodiment may also be realized using a general-purpose computer device as basic hardware. That is, each unit of the system can be realized by causing a processor mounted in the above described computer device to execute a program. In this case, the system may be realized by installing the above described program in the computer device beforehand or may be realized by storing the program in a storage medium such as a CD-ROM or distributing the above described program over a network and installing this program in the computer device as appropriate. Furthermore, the storage/database may also be realized using a memory device or hard disk incorporated in or externally added to the above described computer device or a storage medium such as CD-R, CD-RW, DVD-RAM, DVD-R as appropriate.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

1. A task coordination support system for staffs each holding a mobile terminal, comprising:
a task information storage to store information on tasks to be implemented by the staffs and task flow information showing constraint on order to implement the tasks;
a sensor data receiving unit to receive sensor information from the mobile terminal;
a status storage to store task status information containing received sensor information;
an estimating unit configured to calculate, for each of the tasks, accuracy at which an predetermined implementation status is reached based on the task information storage and the status storage and to estimate a task reached the predetermined implementation status among tasks not yet reached the predetermined implementation status based on calculated accuracy; and
a tweet message generator/deliverer configured to generate a message corresponding to an estimated task, determine as a destination of the message a mobile terminal of a staff previously related to the estimated task which is different from the staff in charge of the estimated task, and deliver the message to a determined mobile terminal.

2. The system according to claim 1, wherein the task information storage stores a time zone for which each task is to be implemented and an implementation location of each task, and
the sensor data receiving unit sequentially obtains location information of the staff as the sensor information.

3. The system according to claim 1, wherein the estimating unit calculates already-implemented accuracy being accuracy at which the implementation of the task is completed as the accuracy which the predetermined implementation status is reached, and determines whether the implementation of the task is completed based on the already-implemented accuracy.

4. The system according to claim 3, wherein the estimating unit further calculates the already-implemented accuracy by use of at least one of items among acceleration of the staff, voice data of the staff and information on whether or not an ID of a patient nearest to the staff is coincident with an ID of a task target patient.

5. The system according to claim 3, wherein the tweet message generator/deliverer includes:
a query unit to transmit a query message of whether the implementation of the task is completed to the mobile terminal of the staff; and
a response receiving unit to receive a response to the query message from the mobile terminal, and
the estimating unit presumes that the implementation of the, task will have been completed when the response indicates that the implementation of the task is completed.

6. The system according to claim 5, wherein the query unit transmits again the query message after a fixed period of time when the response indicates that the implementation of the task is not yet completed.

7. The system according to claim 3, wherein the task information storage stores information on a period of time required for implementing the task, and
the estimating unit adds the period of time required for implementing the task to a time when the staff arrives at the implementation location, and determines that the implementation of the task will have been completed when reaching an added time.

8. The system according to claim 7, wherein the time required for implementing the task is a total of average implementation time of the task and a value obtained by multiplying a standard deviation of the task implementation time by an arbitrary parameter.

9. The system according to claim 3, wherein the sensor data receiving unit receives, as the sensor information, tweet data including implementation status of the task from the mobile terminal, and
the estimating unit estimates a task of which implementation is completed based on the tweet data.

10. The system according to claim 1, wherein the estimating unit estimates a task of which implementation is underway as the task reached the predetermined implementation status, and
the tweet message generator/deliverer transmits a message indicating that the implementation of the estimated task is started to the staff related to the estimated task, which is different from the staff in charge of the estimated task.

11. The system according to claim 10, wherein the estimating unit calculates implementation-underway accuracy being accuracy at which the implementation of the task is underway as the accuracy which the predetermined implementation status is reached, and determines based on the implementation-underway accuracy whether the implementation of the task is underway.

12. The system according to claim 11, wherein the estimating unit further calculates the implementation-underway accuracy by use of at least one of items among acceleration of the staff, voice data of the staff and information on whether or not the ID of the patient nearest to the staff is coincident with the ID of the task target patient.

13. The system according to claim 1, wherein the sensor data receiving unit receives tweet data including task implementation status from the mobile terminal,
the status storage stores the tweet data, and
the tweet message generator/deliverer includes a data browse unit to present, in response to a request given from a mobile terminal, the tweet data in the status storage to the mobile terminal.

14. The system according to claim 13, wherein the tweet data is voice data,
the sensor data receiving unit converts the tweet data into a text format to obtain text data, and
the status storage stores the text data.

15. The system according to claim 14, wherein the sensor data receiving unit extracts a keyword from the text data by a keyword extraction, and
the status storage stores the keyword extracted by the sensor data receiving unit therein.

16. The system according to claim 1, wherein the task information storage retains a time zone for which each task is to be implemented and an implementation location of each task,
the sensor data receiving unit sequentially obtains location information of the staff as the sensor information, and receives tweet data of the staff from the mobile terminal, and
the tweet message generator/deliverer generates a message for notifying that the predetermined implementation status is reached with respect the estimated task, and delivers the message to the determined mobile terminal.

17. The system according to claim 16, wherein the message deliverer delivers the message at timing depending on the destination of the message.

18. The system according to claim 16, wherein each staff belongs to at least one of a plurality of attributes, and
the tweet message generator/deliverer determines at least one of the attributes, and delivers the message to a mobile terminal of a staff belonging to a determined attribute.

19. The system according to claim 16, wherein when there is no task of which the accuracy of the predetermined implementation status is equal to or higher than a threshold value, the tweet message generator/deliverer delivers respective messages to destinations corresponding to tasks of which accuracy of the predetermined implementation status is equal to or higher than a fixed value, the fixed value is lower than the threshold value.

20. The system according to claim 16, wherein the tweet message generator/deliverer uses delivery hint information including delivery purposes of a message for the tasks and determines the destination of the message corresponding to the estimated task based on the delivery purpose of the estimated task.

21. A task coordination support method for staffs each holding a mobile terminal, comprising:
receiving sensor information from the mobile terminal;
storing a task status information containing received sensor information in a status storage;
accessing a task information storage to store information on tasks to be implemented by the staffs and task flow information showing constraint on order to implement the tasks;
calculating, for each of the tasks, accuracy at which an predetermined implementation status is reached based on the task information storage and the status storage and estimating a task reached the predetermined implementation status among tasks not yet reached the predetermined implementation status based on calculated accuracy; and
generating a message corresponding to an estimated task, determining as a destination of the message a mobile terminal of a staff previously related to the estimated task which is different from the staff in charge of the estimated task, and delivering the message to a determined mobile terminal.
